(19) United States
(12) Patent Application Publication
(10) Pub. No.: US 2006/0067022 A1
(43) Pub. Date: Mar. 30, 2006

(54) Fail-safe system for electric power steering in vehicles

(75) Inventors: Thomas James Gallagher, Lake Orion, MI (US); Hong Jiang, Rochester Hills, MI (US); Sergei Kolomeitsev, Rochester, MI (US); John R. Suriano, Auburn Hills, MI (US); Joseph P. Whinnery, Pontiac, MI (US)

Correspondence Address: MATTHEW R. JENKINS, ESQ., 2310 FAR HILLS BUILDING, DAYTON, OH, 45419, US

(73) Assignee: VALEO ELECTRICAL SYSTEMS, INC., AUBURN HILLS, MI (US)

(21) Appl. No.: 10/955,618

(22) Filed: Sep. 30, 2004

(51) Int. Cl. H02H 3/18

(52) U.S. Cl. 361/84

(57) ABSTRACT

A control system for an electric motor used to provide mechanical power to a power steering system in a vehicle. The motor is of the two-phase type with an independent winding for each phase, or of the three-phase type with two independent stator windings. Two inverters are provided, one for each winding. Each inverter provides AC current to run the motor. If a fault is detected in an inverter or its stator winding, current is terminated to that inverter, and the motor is run using the other winding. In addition, if the vehicle battery is installed with incorrect polarity, components within the inverters can be destroyed. The invention detects the incorrect polarity, and blocks current to the inverters.

The invention concerns a system for disconnecting power to dual channel inverters which power an electric motor which operates a power steering system in a vehicle. The electric motor has two sets of stator windings, W1 and W2, and two sets of inverters, I1 and I2. If a fault occurs in W1 or I1, power is terminated to I1, and then I2 and W2 run the motor. Conversely, if a fault occurs in W2 or I2, power is terminated to I2, and then I1 and W1 run the motor.

### BACKGROUND OF THE INVENTION

FIG. 1 illustrates a vehicle 3, which contains an electric motor 6 which operates a power steering linkage (not shown). The motor 6 is commonly of the three-phase permanent magnet brushless DC type. An electronic controller 9 controls an inverter 12, which contains drive transistors (not shown individually), which deliver current to the stator coils (not shown) in the motor.

The Inventors have developed a system for handling malfunctions in motor 6 and inverter 12.

### OBJECTS OF THE INVENTION

An object of the invention is to provide an improved control system for inverters which operate multi-phase permanent magnet brushless DC motors.

A further object of the invention is to provide a system wherein a motor has two sets of stator coils, an inverter for each set of stator coils, and a system for isolating one inverter from the other in the event of certain faults.

### SUMMARY OF THE INVENTION

In one form of the invention, a three-phase brushless permanent magnet electric motor is constructed having two sets of stator coils. Two inverters are used, one for each set of coils. If a malfunction in one inverter, or its set of coils, is detected, current is terminated to that inverter, and the other inverter, and its set of coils, run the motor. In addition, if the primary storage battery of the vehicle is installed with incorrect polarity, current is terminated to both inverters, to prevent damage to the inverters.

In one aspect, this invention comprises an apparatus for use with an inverter which drives a motor in a vehicle which contains a primary storage battery, comprising means for preventing damage to the inverter if the primary storage battery is installed with incorrect polarity and means for detecting a fault in the inverter or motor, and, in response, terminating current to the motor without use of a star-point relay within the motor.

In another aspect, this invention comprises an apparatus for use with an inverter which drives a motor in a vehicle which contains a primary storage battery, comprising a relay which delivers current to the inverter, which current the inverter uses to generate AC power for the motor, means for ascertaining whether the primary storage battery is connected to the vehicle with correct polarity and, if not, opening the relay, means for monitoring the inverter, the motor, or both, and if a predetermined type of fault is detected, opening the relay to thereby terminate current to the motor.

In still another aspect, this invention comprises a system, comprising a vehicle, an electric motor which drives a power steering system in the vehicle and which is driven by an inverter, a relay which controls power delivered to the inverter, wherein no star-point relay is present within the motor.

In yet another aspect, this invention comprises a system, comprising a vehicle, an electric motor which drives a power steering system in the vehicle, and which contains a first and a second set of stator coils, wherein the current in each set is independent of current in the other; receives power for the first set of stator coils from a first inverter, and receives power for the second set of stator coils from a second inverter, a first relay which controls current delivered to the first inverter, and a second relay which controls current delivered to the second inverter.

In still another aspect, this invention comprises a method of operating a motor which is powered by an inverter in a vehicle which contains an engine, comprising maintaining a relay which terminates current to the inverter when in an open state, and delivers current to the inverter when in a closed state; ascertaining whether battery polarity is correct and if not correct, maintaining the relay in the open state; and if correct, closing the relay; and monitoring the inverter, the motor, or both and if a predetermined type of fault occurs, opening the relay.

In yet another aspect, this invention comprises for an electric motor which drives a power steering system in a vehicle which contains a primary storage battery, a method comprising: maintaining a first and a second set of stator coils in the motor, wherein the current in each set is independent of current in the other; maintaining a first inverter which delivers current to the first set of stator coils; maintaining a second inverter which delivers current to the second set of stator coils; maintaining a first relay which controls current delivered to the first inverter, and maintaining a second relay which controls current delivered to the second inverter.

In still another aspect, this invention comprises a method of operating a motor in a vehicle which contains a primary storage battery, comprising: maintaining two independent sets of stator coils in the motor; maintaining two inverters, one for each set of stator coils; ascertaining whether the primary storage battery is installed in the vehicle with proper polarity and, if not, blocking current to both inverters; ascertaining whether a fault exists in a set of stator coils or its associated inverter and, if so, blocking current to the stator coils or inverter containing the fault.

In yet another aspect, this invention comprises a method, comprising: maintaining a relay in series with an inverter which powers a motor in a vehicle; if a primary storage battery in the vehicle is installed with incorrect polarity, opening the relay; and if a predetermined fault is detected in the motor or inverter, opening the relay.

In still another aspect, this invention comprises an apparatus for use with a relay in series with an inverter which powers a motor in a vehicle; means for opening the relay if a primary storage battery in the vehicle is installed with incorrect polarity; and means for opening the relay if a predetermined fault is detected in the motor or inverter.

Other objects and advantages of the invention will be apparent from the following description and the accompanying drawings.

### BRIEF DESCRIPTION OF THE DRAWINGS

FIG. 1 illustrates a prior-art motor vehicle.

FIG. 2 illustrates a prior-art inverter, and three stator coils C1, C2, and C3.

FIG. 3 illustrates magnetic fields B1, B2, and B3 generated by the coils C1, C2, and C3, also shown in FIG. 2.

FIG. 4 illustrates the resultant rotating magnetic field BR, produced by the fields B1, B2, and B3 of FIG. 3.

FIG. 5 illustrates the Inventors' illustration of a short circuit L in coils C1 and C2, and the current I which is induced in those coils by the rotating magnetic field B of the rotor. This magnetic field B is different from the resultant field BR of FIG. 4.

FIG. 6 illustrates a relay 24 which is used to eliminate the Y-connection of the stator coils, and thus terminate current in all coils.

FIG. 7 illustrates one form of the invention.

FIG. 8 illustrates the apparatus of FIG. 7, but with relay 50 in an open state.

FIG. 9 illustrates another form of the invention.

### DETAILED DESCRIPTION OF THE INVENTION

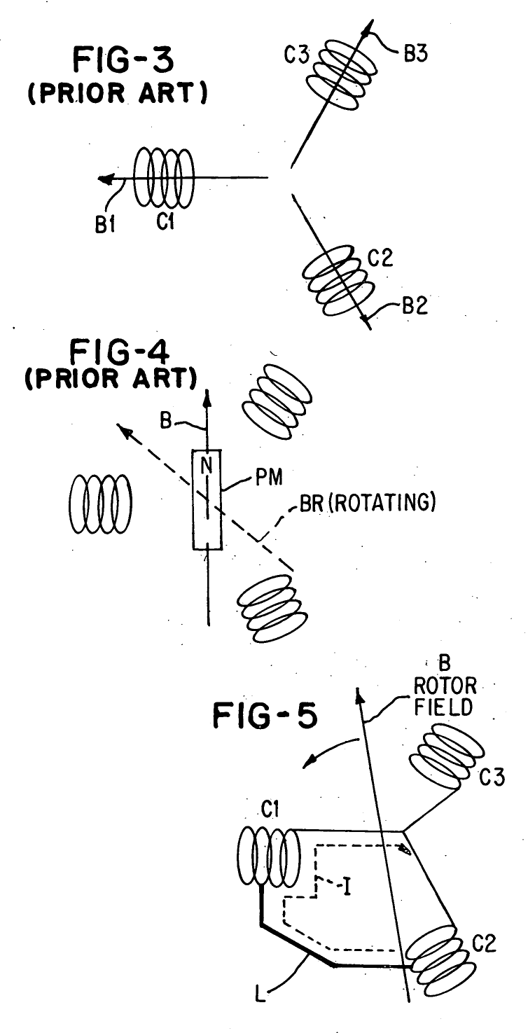

FIG. 2 illustrates a generalized stator 14, or phase windings, used in a three-phase permanent-magnet brushless DC motor. A battery BAT provides electrical power. Transistors T1-T6 are triggered by a control system, not shown but known in the art, to generate synchronized currents in coils C1-C3. The currents produce magnetic fields, shown in FIG. 3, and labeled B1, B2, and B3.

If the fields B1-B3 are properly synchronized, they will vectorially add to a single rotating magnetic field, indicated as BR in FIG. 4.

If a rotor containing a permanent magnet PM is positioned as in FIG. 4, the permanent magnet PM will continually attempt to align its magnetic field B with the rotating magnetic field BR, thereby causing rotation of the rotor.

If, during rotation, a certain type of short circuit occurs, part of the motor can be converted into a generator, causing periodic drag on the rotor. Since the rotor is mechanically linked to the steering wheel of the vehicle, this drag can be sensed by the driver, and may cause inconvenience.

FIG. 5 illustrates how the drag can be created. Assume that a short circuit occurs between two stator coils C1 and C2, indicated by line L. When the rotor field B sweeps past coils C1 and C2, it induces a current I. Because the coils contain some finite electrical resistance, joule heating is induced by the current I. The energy needed to supply that joule heating is extracted from the rotor, thus causing a drag on the rotor.

In more simple terms, coils C1 and C2, together with the rotating field B, act as a generator. Energy is required to rotate the field B, and that is supplied by deceleration of the rotor each time its field B sweeps past coils C1 and C2.

In some situations, a relay is provided to block currents, such as current I in FIG. 5. FIG. 6 illustrates such a relay 24. Separate monitoring circuitry (not shown) detects a fault, such as current I in FIG. 5, and, in response, opens the relay 24. Opening the relay 24 shuts down the motor.

However, relay 24 imposes several disadvantages. One is that, as a practical matter, relay 24 must be installed within the housing of the motor because it is not desirable to run wires W1-W3 in FIG. 6 to an external location. This internal installation increases the size, and thus expense, of the motor housing. In addition, servicing the relay is made more difficult, because it must be removed from the motor housing.

A second disadvantage is that the currents which relay 24 must handle are large, making relay 24 expensive.

An additional feature of the system of FIG. 6 is that a second relay 30 is provided, to disconnect power from the transistors T1-T6. This second relay 30 is needed to prevent damage occurring in the event that the primary vehicle storage battery (not shown) is installed with reverse polarity.

Reverse polarity is hazardous, because each transistor in FIG. 6 is equipped with a flyback diode, such as diode D associated with transistor T1. If the battery is installed with correct polarity, then the actual polarity across diode D corresponds to that indicated by the positive and negative symbols. Diode D at this time is reverse-biased, and only an extremely small current flows through diode D at this time.

However, if the battery is installed with reverse polarity, then the polarity across the diode D is the reverse of that indicated by the positive/negative symbols shown in FIG. 6. The diode becomes forward-biased. An enormous current flows, which will destroy the transistor T1.

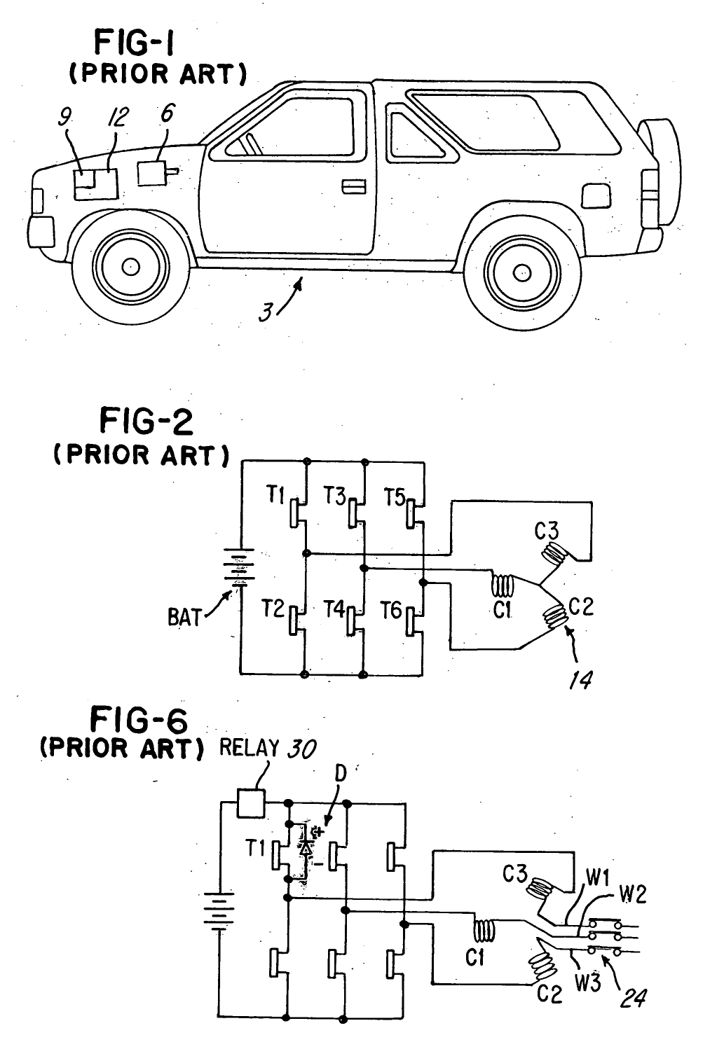

To prevent this destruction of transistor T1, monitoring circuitry, most likely contained within the controller 9 in FIG. 1, detects polarity of the vehicle's main battery. If the polarity is correct, then relay 30 in FIG. 6 is closed. If polarity is incorrect, then relay 30 remains open.

As a simple example, a diode (not shown) can be connected in series with the actuating coil (not shown) of relay 30. When the battery polarity is correct, the diode conducts, the coil becomes energized, and the relay 30 closes, thereby delivering current. Conversely, if the battery polarity is incorrect, the diode is reverse-biased, no current flows through the coil, and the relay 30 remains open. Of course, more sophisticated approaches can be taken.

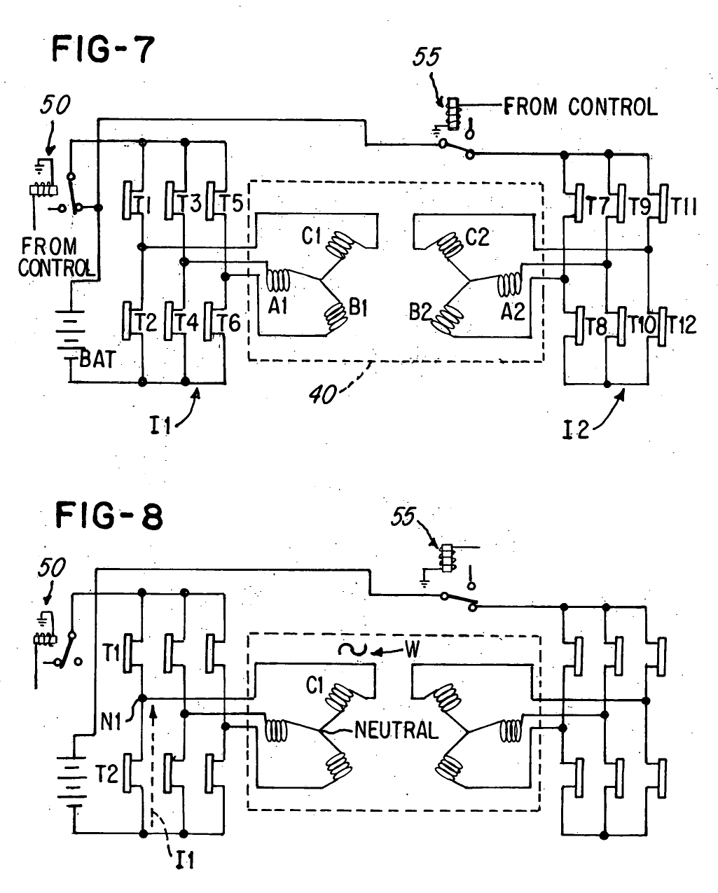

FIG. 7 illustrates one form of the invention. A motor 40 is provided, having two sets of stator coils, the first set being labeled A1, B1, C1, and the second set labeled A2, B2, C2. In concept, the motor 40 can be viewed as two three-phase brushless permanent magnet motors with their shafts rigidly coupled together to make them co-linear.

Each set of stator coils receives power from its own inverter, I1 and I2, as indicated. Each inverter I1 and I2 receives power through a respective relay 50 and 55. The inverters I1 and I2 are independent of each other, as are the two sets of stator coils.

Relays 50 and 55 allow power from the battery BAT to reach the two inverters I1 and I2. Relays 50 and 55 can be controlled by the same control system which synchronizes the firing of the transistors in the inverters 11 and 12.

That control system, or an auxiliary system, contains detection circuitry, known in the art, which detects predetermined types of faults. When a fault is detected, in either a set of phase windings or the inverter controlling those phase windings, then the relay driving the inverter involved is opened. Four specific examples will illustrate.

### EXAMPLE 1

If a short circuit is detected in coil C1 in FIG. 7, then relay 50 is opened. Relay 55 remains closed, supplying power to inverter I2 as usual.

### EXAMPLE 2

If a short circuit is detected in transistor T1, then relay 50 is opened. Relay 55 remains closed, supplying power to inverter I2.

### EXAMPLE 3

If a short circuit is detected in coil B2 in FIG. 7, then relay 55 is opened. Relay 50 remains closed, supplying power to inverter I1.

### EXAMPLE 4

If a short circuit is detected in transistor T8, for example, then relay 55 is opened. Relay 50 remains closed, supplying power to inverter I1.

Stated in different terms, two components can be defined. One component includes inverter I1 and coil set A1, B1, and C1, which inverter I1 powers. The other component includes inverter I2 and coil set A2, B2, and C2, which inverter I2 powers. If a fault is detected in one component, the relay powering that component is opened, while the other relay delivers power to the other component.

### Significant Features

One feature of the invention is that the overall motor 40 in FIG. 7, and its inverter, is divided into two redundant sub-systems. If a short circuit occurs between, for example, coils A1 and B1, causing the problem described in connection with FIG. 5, then relay 50 in Figure is opened, terminating power to inverter I1. Relay 55 remains closed, delivering power to inverter I2.

Even if the short circuit causes a drag on the rotor, the power delivered to coils A2, B2, and C2 overcomes the drag.

A second feature is that no relay corresponding to relay 30 in FIG. 6 is needed. Relays 50 and 55 in FIG. 7 can adopt the function of relay 30 of FIG. 6. That is, if the primary storage battery in the vehicle is installed incorrectly, then both relays 50 and 55 remain open. If the polarity is correct, relays 50 and 55 are closed, or at least are not opened because of faulty polarity. They could be opened for other reasons. Also, relays 50 and 55 will be less expensive than relay 30, since they only need to conduct half the current of relay 30.

### Additional Considerations

1. When a fault is detected, the control system may issue a warning to the driver, as by illuminating a lamp on the dashboard. Alternately, the control system may issue a fault code, which is stored in the on-board computer, and later read out by a technician.

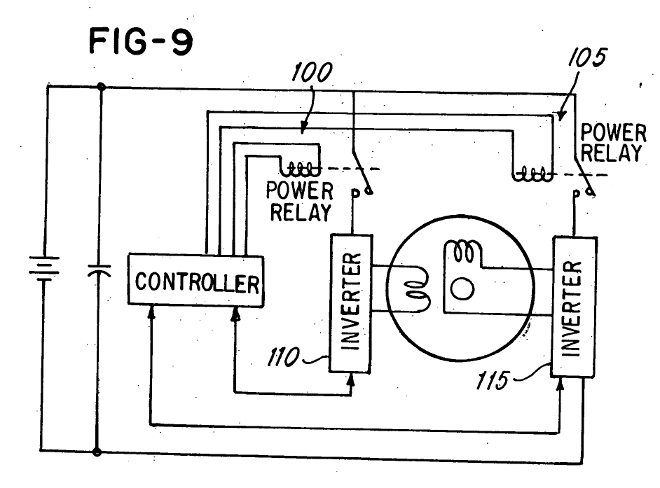

2. It is not necessary to use a three-phase motor. FIG. 9 illustrates the invention used with a two-phase motor. Relays 100 and 105 control the current delivered to inverters 110 and 115. If a fault is detected, the relay involved is opened, as above. If the battery polarity is incorrect, both relays are opened, as above.

3. Under the invention, the need for star-point relay 24 in FIG. 6 is eliminated. The invention operates without a star-point relay inside the motor housing.

Numerous substitutions and modifications can be undertaken without departing from the true spirit and scope of the invention. What is desired to be secured by Letters Patent is the invention as defined in the following claims.

1. An apparatus for use with an inverter which drives a motor in a vehicle which contains a primary storage battery, comprising:
a) means for preventing damage to the inverter if the primary storage battery is installed with incorrect polarity; and
b) means for detecting a fault in the inverter or motor, and, in response, terminating current to the motor without use of a star-point relay within the motor.

2. The apparatus according to claim 1, wherein both means control a common relay, which opens to prevent the damage of paragraph (a).

3. The apparatus according to claim 1, wherein the motor provides mechanical power to a power steering system.

4. An apparatus for use with an inverter which drives a motor in a vehicle which contains a primary storage battery, comprising:
a) a relay which delivers current to the inverter, which current the inverter uses to generate AC power for the motor;
b) means for ascertaining whether the primary storage battery is connected to the vehicle with correct polarity and, if not, opening the relay;
c) means for monitoring the inverter, the motor or both, and if a predetermined type of fault is detected, opening the relay to thereby terminate current to the motor.

5. The apparatus according to claim 4, wherein no star-point relay is present within the motor.

6. A system, comprising:
a) a vehicle;
b) an electric motor which drives a power steering system in the vehicle and which is driven by an inverter;
c) a relay which controls power delivered to the inverter, wherein no star-point relay is present within the motor.

7. The system according to claim 6, wherein the vehicle is powered by an engine and contains a primary storage battery, and further comprising:
c) means for ascertaining whether the primary storage battery is connected with correct polarity and
i) if not, maintaining the relay in an open state, and
ii) if polarity is correct, closing the relay.

8. The system according to claim 7, and further comprising:
d) means for ascertaining whether a predetermined type of fault occurs in the motor or inverter and, if so, opening the relay.

9. A system, comprising:
a) a vehicle;
b) an electric motor which drives a power steering system in the vehicle, and which
i) contains a first and a second set of stator coils, wherein the current in each set is independent of current in the other;
ii) receives power for the first set of stator coils from a first inverter, and receives power for the second set of stator coils from a second inverter;
c) a first relay which controls current delivered to the first inverter, and
d) a second relay which controls current delivered to the second inverter.

10. The system according to claim 9, wherein no star-point relay is present within the motor.

11. The system according to claim 9, and further comprising:
e) means for ascertaining whether a predetermined type of fault occurs in the first set of stator coils or the first inverter and, if so, opening the first relay to thereby terminate current to the first inverter.

12. The system according to claim 11, and further comprising:
e) means for ascertaining whether a predetermined type of fault occurs in the second set of stator coils or the second inverter and, if so, opening the second relay to thereby terminate current to the second inverter.

13. The system according to claim 12 wherein the vehicle comprises a primary storage battery, and further comprising:
f) means for ascertaining whether the primary battery is connected to the vehicle with correct polarity and, if not, maintaining both the first and second relays in an open state.

14. A method of operating a motor which is powered by an inverter in a vehicle which contains an engine, comprising the steps of:
a) maintaining a relay which
i) terminates current to the inverter when in an open state, and
ii) delivers current to the inverter when in a closed state;
b) ascertaining whether battery polarity is correct and
i) if not correct, maintaining the relay in the open state; and
ii) if correct, closing the relay; and
d) monitoring the inverter, the motor, or both and if a predetermined type of fault occurs, opening the relay.

15. The method according to claim 14, wherein the motor comprises three phases in Y-connection at a node, and further comprising:
e) maintaining no relay which makes and breaks the Y-connection at the node.

16. The method according to claim 14, wherein no relay is present within the motor.

17. For an electric motor which drives a power steering system in a vehicle which contains a primary storage battery, a method comprising the steps of:
a) maintaining a first and a second set of stator coils in the motor, wherein the current in each set is independent of current in the other;
b) maintaining a first inverter which delivers current to the first set of stator coils;
c) maintaining a second inverter which delivers current to the second set of stator coils;
d) maintaining a first relay which controls current delivered to the first inverter, and
e) maintaining a second relay which controls current delivered to the second inverter.

18. The method according to claim 17, and further comprising:
f) ascertaining whether the primary storage battery is installed in the vehicle with proper polarity and, if not, opening the first and second relays.

19. The method according to claim 18, and further comprising:
g) monitoring the first inverter, the first set of stator coils, or both, and if a predetermined type of fault is detected, opening the first relay while keeping the second relay closed.

20. The method according to claim 19, and further comprising:
g) monitoring the second inverter, the second set of stator coils, or both, and if a predetermined type of fault is detected, opening the second relay while keeping the first relay closed.

21. A method of operating a motor in a vehicle which contains a primary storage battery, comprising:
a) maintaining two independent sets of stator coils in the motor;
b) maintaining two inverters, one for each set of stator coils;
c) ascertaining whether the primary storage battery is installed in the vehicle with proper polarity and, if not, blocking current to both inverters;
d) ascertaining whether a fault exists in a set of stator coils or its associated inverter and, if so, blocking current to the stator coils or inverter containing the fault.

22. A method, comprising:
a) maintaining a relay in series with an inverter which powers a motor in a vehicle;
b) if a primary storage battery in the vehicle is installed with incorrect polarity, opening the relay; and
c) if a predetermined fault is detected in the motor or inverter, opening the relay.

23. An apparatus for use with a relay in series with an inverter which powers a motor in a vehicle;
a) means for opening the relay if a primary storage battery in the vehicle is installed with incorrect polarity; and
b) means for opening the relay if a predetermined fault is detected in the motor or inverter.
